(19) United States
(12) Patent Application Publication
(10) Pub. No.: US 2026/0321119 A1
(43) Pub. Date: Oct. 15, 2026

(54) DISPENSER ALARM SYSTEM

(71) Applicant: OP-HYGIENE IP GmbH, Niederbipp (CH)

(72) Inventors: Heiner Ophardt, Arisdorf (CH); Joel Ophardt, Smithville (CA); David Issler, Wangen an der Aare (CH); Patrick Stressler, Meerbusch (DE)

(21) Appl. No.: 19/642,785

(22) Filed: Apr. 9, 2026

Related U.S. Application Data
(60) Provisional application No. 63/788,900, filed on Apr. 15, 2025.

(51) Int. Cl. G08B 21/02; G01S 17/88

(52) U.S. Cl. CPC G08B 21/02; G01S 17/88

(57) ABSTRACT

A hygiene apparatus having a sensor and a communication device. The sensor is configured to detect at least one type of dangerous interaction with the hygiene apparatus. The communication device is configured to produce a warning signal on detection of the dangerous interaction.

### RELATED APPLICATION

This application claims priority to the 15 Apr. 2025 filing date of United States Provisional Patent Application Serial No. 63/788,900, which is incorporated herein by reference.

### FIELD OF THE INVENTION

This invention relates to hygiene product dispensers, such as hand cleaning fluid dispensers, paper towel dispensers, and bathroom tissue dispensers.

### BACKGROUND OF THE INVENTION

Hygiene product dispensers, such as hand cleaning fluid dispensers, paper towel dispensers, and bathroom tissue dispensers, provide access to products that are important for maintaining good health and hygiene, and can be found in a wide variety of different environments, including schools, hospitals, restaurants, office buildings, and shopping centers.

Hygiene product dispensers are sometimes installed in environments that house vulnerable people, who may be at risk of harming themselves or others, such as prisons, rehabilitation facilities, and mental health facilities. In these environments, there is a risk that individuals may attempt to use hygiene product dispensers as weapons or for self-harm.

### SUMMARY OF THE INVENTION

To at least partially overcome some of the disadvantages of previously known systems, devices and methods, in one aspect the present invention provides a hygiene apparatus having a sensor that is configured to detect at least one type of dangerous interaction with the hygiene apparatus. The hygiene apparatus also includes a communication device that is configured to produce a warning signal on detection of the dangerous interaction.

The applicant has appreciated that the hygiene apparatus in accordance with the invention can advantageously provide a warning when a dangerous interaction with the hygiene apparatus is detected. This preferably allows nearby personnel, such as prison guards or healthcare workers, to quickly intervene to prevent or minimize the risk of injury.

The warning signal can, for example, be in the form of one or more of: an acoustic signal, such as an audible alarm; a visual signal, such as an illuminated or flashing light; or a wireless communication signal that sends a notification directly or indirectly to one or more external devices, such as a smartphone or a computer network. The computer network may, for example, include software that processes the warning signal and relays the warning to other devices, such as through a push notification.

In some embodiments of the invention, the sensor comprises a ligature sensor which can detect if the hygiene apparatus is being used for self-harm. For example, in some embodiments of the invention the hygiene apparatus is configured to be mounted to a support structure, and the sensor is configured to detect an external object that is placed between the hygiene apparatus and the support structure. The sensor may, for example, include a catch member that is configured to engage with the external object, which triggers communication of the warning signal.

In other embodiments of the invention, the sensor could include one or more of: an optical sensor, an infrared radiation emitter and detector, or a time of flight sensor, which are configured to detect the insertion of an external object.

Preferably, the hygiene apparatus includes a guide member that is configured to guide the external object into a detection zone where the object will be detected by the sensor.

In some embodiments of the invention, the sensor may be configured to detect if the hygiene apparatus has been removed from the support structure. For example, the sensor may include a mechanical switch that is in a first position when the hygiene apparatus is attached to the support structure, and moves to a second position when the hygiene apparatus is removed from the support structure. Movement of the switch from the first position to the second position can be used to trigger the warning signal, which preferably allows nearby personnel, such as prison guards or healthcare workers, to intervene to prevent the hygiene apparatus from being used as a weapon or otherwise used in a dangerous manner.

The hygiene apparatus could also include one or more of: a weight sensor or a force sensor to detect unexpected or undesirable forces being applied to the apparatus; a piezoelectric sensor, to detect mechanical tension applied to the apparatus; an accelerometer, which detects unexpected accelerations, such as if the apparatus is removed or falls from the support structure; an orientation sensor, such as a gyroscope, which detects if the apparatus is in an unexpected orientation; or a vibration sensor, which detects unexpected or excessive vibrations.

The apparatus may also include one or more sensors that detect if the apparatus is being set on fire, or is otherwise being subjected to unexpected or undesirable heat loads. The sensors may include, for example, a smoke detector, a fire detector, and/or a heat detector. The applicant has appreciated that incorporating these sensors directly into the hygiene apparatus can preferably provide an earlier warning that the apparatus is being set on fire, compared, for example, to a smoke detector that is positioned on a ceiling spaced from the hygiene apparatus. This preferably allows nearby personnel to intervene quickly to prevent the apparatus from igniting, or to put out the fire before it has had time to spread or get out of control.

Further aspects of the invention include:
1. A hygiene apparatus, which optionally incorporates one or more features of any one or more of the preceding and/or following aspects, comprising: a sensor that is configured to detect at least one type of dangerous interaction with the hygiene apparatus; and a communication device that is configured to produce a warning signal on detection of the dangerous interaction.
2. A hygiene apparatus, which optionally incorporates one or more features of any one or more of the preceding and/or following aspects, wherein the hygiene apparatus comprises a hand cleaning fluid dispenser.
3. A hygiene apparatus, which optionally incorporates one or more features of any one or more of the preceding and/or following aspects, wherein the hygiene apparatus comprises a bathroom tissue dispenser.
4. A hygiene apparatus, which optionally incorporates one or more features of any one or more of the preceding and/or following aspects, wherein the hygiene apparatus comprises a hand towel dispenser.
5. A hygiene apparatus, which optionally incorporates one or more features of any one or more of the preceding and/or following aspects, wherein the warning signal comprises an acoustic signal.
6. A hygiene apparatus, which optionally incorporates one or more features of any one or more of the preceding and/or following aspects, wherein the acoustic signal comprises an audible alarm.
7. A hygiene apparatus, which optionally incorporates one or more features of any one or more of the preceding and/or following aspects, wherein the warning signal comprises a visual signal.
8. A hygiene apparatus, which optionally incorporates one or more features of any one or more of the preceding and/or following aspects, wherein the visual signal comprises an illuminated light.
9. A hygiene apparatus, which optionally incorporates one or more features of any one or more of the preceding and/or following aspects, wherein the visual signal comprises a flashing light.
10. A hygiene apparatus, which optionally incorporates one or more features of any one or more of the preceding and/or following aspects, wherein the warning signal comprises an electronic signal for notifying an external device that the dangerous interaction was detected.
11. A hygiene apparatus, which optionally incorporates one or more features of any one or more of the preceding and/or following aspects, wherein the warning signal comprises a wireless signal for notifying an external device that the dangerous interaction was detected.
12. A hygiene apparatus, which optionally incorporates one or more features of any one or more of the preceding and/or following aspects, wherein the sensor comprises a ligature sensor.
13. A hygiene apparatus, which optionally incorporates one or more features of any one or more of the preceding and/or following aspects, wherein the hygiene apparatus is configured to be mounted to a support structure; wherein the hygiene apparatus comprises an interface portion that is adjacent to the support structure; and wherein the sensor is configured to detect an external object placed within the interface portion.
14. A hygiene apparatus, which optionally incorporates one or more features of any one or more of the preceding and/or following aspects, wherein the hygiene apparatus is configured to be mounted to a vertical support surface of the support structure.
15. A hygiene apparatus, which optionally incorporates one or more features of any one or more of the preceding and/or following aspects, wherein the support structure comprises a wall.
16. A hygiene apparatus, which optionally incorporates one or more features of any one or more of the preceding and/or following aspects, wherein the sensor comprises a catch member that is configured to engage with the external object when the external object is placed within the interface portion; and wherein the sensor is configured to detect when the external object engages with the catch member.
17. A hygiene apparatus, which optionally incorporates one or more features of any one or more of the preceding and/or following aspects, wherein the catch member comprises a finger that extends horizontally within the interface portion.
18. A hygiene apparatus, which optionally incorporates one or more features of any one or more of the preceding and/or following aspects, wherein the sensor comprises a mechanical switch that is triggered by engagement of the external object with the catch member.
19. A hygiene apparatus, which optionally incorporates one or more features of any one or more of the preceding and/or following aspects, further comprising a guide member that, when the external object is placed within the interface portion, is configured to guide the external object into engagement with the catch member.
20. A hygiene apparatus, which optionally incorporates one or more features of any one or more of the preceding and/or following aspects, wherein the guide member comprises: a support engagement surface that is configured to engage with the support structure; and a guide surface that is configured to engage with the external object to guide the external object to a detection zone within the interface portion.
21. A hygiene apparatus, which optionally incorporates one or more features of any one or more of the preceding and/or following aspects, wherein, when the hygiene apparatus is mounted vertically, the guide surface slopes downwardly and outwardly away from the support structure.
22. A hygiene apparatus, which optionally incorporates one or more features of any one or more of the preceding and/or following aspects, further comprising a back plate that is configured to be fastened to the support structure; wherein the back plate has an external surface that faces towards the support structure and an internal surface that faces away from the support structure; and wherein the detection zone is located adjacent to the internal surface of the back plate.
23. A hygiene apparatus, which optionally incorporates one or more features of any one or more of the preceding and/or following aspects, wherein the catch member extends across the detection zone and into an opening in the back plate.
24. A hygiene apparatus, which optionally incorporates one or more features of any one or more of the preceding and/or following aspects, wherein the guide member is formed by a top portion of the back plate.
25. A hygiene apparatus, which optionally incorporates one or more features of any one or more of the preceding and/or following aspects, wherein the external object comprises a ligature.
26. A hygiene apparatus, which optionally incorporates one or more features of any one or more of the preceding and/or following aspects, wherein the sensor comprises an optical sensor.
27. A hygiene apparatus, which optionally incorporates one or more features of any one or more of the preceding and/or following aspects, wherein the sensor comprises a radiation emitter and a radiation detector.
28. A hygiene apparatus, which optionally incorporates one or more features of any one or more of the preceding and/or following aspects, wherein the radiation emitter generates a beam of radiation that extends across a detection zone of the interface portion; and wherein the radiation detector detects when the radiation beam is obstructed by passage of the external object through the detection zone.
29. A hygiene apparatus, which optionally incorporates one or more features of any one or more of the preceding and/or following aspects, further comprising a guide member that, when the external object is placed within the interface portion, is configured to guide the external object into the detection zone.
30. A hygiene apparatus, which optionally incorporates one or more features of any one or more of the preceding and/or following aspects, further comprising a back plate that is configured to be fastened to the support structure; wherein the back plate has an external surface that faces towards the support structure and an internal surface that faces away from the support structure; and wherein the detection zone is located adjacent to the internal surface of the back plate.
31. A hygiene apparatus, which optionally incorporates one or more features of any one or more of the preceding and/or following aspects, wherein at least one of the radiation emitter and the radiation detector is located on the back plate.
32. A hygiene apparatus, which optionally incorporates one or more features of any one or more of the preceding and/or following aspects, wherein both the radiation emitter and the radiation detector are spaced from the back plate, and wherein the back plate comprises a reflective surface for reflecting the beam of radiation towards the radiation detector.
33. A hygiene apparatus, which optionally incorporates one or more features of any one or more of the preceding and/or following aspects, wherein the beam of radiation comprises infrared radiation.
34. A hygiene apparatus, which optionally incorporates one or more features of any one or more of the preceding and/or following aspects, wherein the sensor comprises a time of flight sensor.
35. A hygiene apparatus, which optionally incorporates one or more features of any one or more of the preceding and/or following aspects, wherein the hygiene apparatus is configured to be mounted to a support structure; and wherein the sensor is configured to detect if the hygiene apparatus has been removed from the support structure.
36. A hygiene apparatus, which optionally incorporates one or more features of any one or more of the preceding and/or following aspects, wherein the sensor comprises a mechanical switch that is moveable between a first position and a second position; and wherein the mechanical switch is configured to move from the first position to the second position upon removal of the hygiene apparatus from the support structure.
37. A hygiene apparatus, which optionally incorporates one or more features of any one or more of the preceding and/or following aspects, further comprising a biasing member that biases the mechanical switch towards the second position; wherein, when the hygiene apparatus is mounted to the support structure, the support structure engages with the mechanical switch so as to hold the mechanical switch in the first position; and wherein, when the hygiene apparatus is removed from the support structure, the mechanical switch disengages from the support structure and moves to the second position under the bias of the biasing member.
38. A hygiene apparatus, which optionally incorporates one or more features of any one or more of the preceding and/or following aspects, wherein the sensor comprises a force sensor.
39. A hygiene apparatus, which optionally incorporates one or more features of any one or more of the preceding and/or following aspects, wherein the warning signal is produced when the force sensor detects a force applied to the hygiene apparatus that exceeds a force threshold.
40. A hygiene apparatus, which optionally incorporates one or more features of any one or more of the preceding and/or following aspects, wherein the sensor comprises a piezoelectric sensor.
41. A hygiene apparatus, which optionally incorporates one or more features of any one or more of the preceding and/or following aspects, wherein the piezoelectric sensor is configured to detect mechanical tension applied to the hygiene apparatus.
42. A hygiene apparatus, which optionally incorporates one or more features of any one or more of the preceding and/or following aspects, wherein the warning signal is produced when the piezoelectric sensor detects mechanical tension applied to the hygiene apparatus that exceeds a mechanical tension threshold.
43. A hygiene apparatus, which optionally incorporates one or more features of any one or more of the preceding and/or following aspects, wherein the sensor comprises an accelerometer.
44. A hygiene apparatus, which optionally incorporates one or more features of any one or more of the preceding and/or following aspects, wherein the warning signal is produced when the accelerometer detects that the hygiene apparatus has fallen or has moved in an unexpected way.
45. A hygiene apparatus, which optionally incorporates one or more features of any one or more of the preceding and/or following aspects, wherein the sensor comprises an orientation sensor.
46. A hygiene apparatus, which optionally incorporates one or more features of any one or more of the preceding and/or following aspects, wherein the orientation sensor comprises a gyroscope.
47. A hygiene apparatus, which optionally incorporates one or more features of any one or more of the preceding and/or following aspects, wherein the warning signal is produced when the orientation sensor detects that the hygiene apparatus is in an unexpected orientation.
48. A hygiene apparatus, which optionally incorporates one or more features of any one or more of the preceding and/or following aspects, wherein the sensor comprises a vibration sensor.
49. A hygiene apparatus, which optionally incorporates one or more features of any one or more of the preceding and/or following aspects, wherein the warning signal is produced when the vibration sensor detects vibrations of the hygiene apparatus that exceed a vibration threshold.
50. A hygiene apparatus, which optionally incorporates one or more features of any one or more of the preceding and/or following aspects, wherein the sensor comprises at least one of: a smoke detector, a fire detector, and a heat detector.
51. A method, which optionally incorporates one or more features of any one or more of the preceding and/or following aspects, comprising: providing a hygiene apparatus having a communication device and a sensor that is configured to detect at least one type of dangerous interaction with the hygiene apparatus; and using the communication device to produce a warning signal on detection of the dangerous interaction.
52. A method, which optionally incorporates one or more features of any one or more of the preceding and/or following aspects, wherein the hygiene apparatus comprises the hygiene apparatus as described in any one of aspects 1 to 50.
53. A hygiene apparatus, which optionally incorporates one or more features of any one or more of the preceding and/or following aspects, comprising: at least one sensor that is configured to detect at least one type of dangerous interaction with the hygiene apparatus; and a communication device that is configured to produce a warning signal on detection of the dangerous interaction.
54. A hygiene apparatus, which optionally incorporates one or more features of any one or more of the preceding and/or following aspects, wherein the hygiene apparatus comprises at least one of: a hand cleaning fluid dispenser; a bathroom tissue dispenser; and a hand towel dispenser.
55. A hygiene apparatus, which optionally incorporates one or more features of any one or more of the preceding and/or following aspects, wherein the hygiene apparatus is configured to be mounted to a support structure; wherein the hygiene apparatus comprises an interface portion that is adjacent to the support structure; and wherein the at least one sensor is configured to detect an external object placed within the interface portion.
56. A hygiene apparatus, which optionally incorporates one or more features of any one or more of the preceding and/or following aspects, wherein the at least one sensor comprises a catch member that is configured to engage with the external object when the external object is placed within a detection zone of the interface portion; and wherein the at least one sensor is configured to detect when the external object engages with the catch member.
57. A hygiene apparatus, which optionally incorporates one or more features of any one or more of the preceding and/or following aspects, wherein the at least one sensor comprises a radiation emitter and a radiation detector; wherein the radiation emitter generates a beam of radiation that extends across a detection zone of the interface portion; and wherein the radiation detector detects when the radiation beam is obstructed by passage of the external object through the detection zone.
58. A hygiene apparatus, which optionally incorporates one or more features of any one or more of the preceding and/or following aspects, further comprising a guide member that, when the external object is placed within the interface portion, is configured to guide the external object into the detection zone.
59. A hygiene apparatus, which optionally incorporates one or more features of any one or more of the preceding and/or following aspects, wherein the guide member comprises: a support engagement surface that is configured to engage with the support structure; and a guide surface that is configured to engage with the external object to guide the external object to the detection zone.
60. A hygiene apparatus, which optionally incorporates one or more features of any one or more of the preceding and/or following aspects, wherein, when the hygiene apparatus is mounted vertically, the guide surface slopes downwardly and outwardly away from the support structure.
61. A hygiene apparatus, which optionally incorporates one or more features of any one or more of the preceding and/or following aspects, further comprising a back plate that is configured to be fastened to the support structure; wherein the back plate has an external surface that faces towards the support structure and an internal surface that faces away from the support structure; and wherein the detection zone is located adjacent to the internal surface of the back plate.
62. A hygiene apparatus, which optionally incorporates one or more features of any one or more of the preceding and/or following aspects, wherein the catch member extends across the detection zone and into an opening in the back plate.
63. A hygiene apparatus, which optionally incorporates one or more features of any one or more of the preceding and/or following aspects, wherein at least one of the radiation emitter and the radiation detector is located on the back plate.
64. A hygiene apparatus, which optionally incorporates one or more features of any one or more of the preceding and/or following aspects, wherein both the radiation emitter and the radiation detector are spaced from the back plate, and wherein the back plate comprises a reflective surface for reflecting the beam of radiation towards the radiation detector.
65. A hygiene apparatus, which optionally incorporates one or more features of any one or more of the preceding and/or following aspects, wherein the hygiene apparatus is configured to be mounted to a support structure; and wherein the at least one sensor is configured to detect if the hygiene apparatus has been removed from the support structure.
66. A hygiene apparatus, which optionally incorporates one or more features of any one or more of the preceding and/or following aspects, wherein the at least one sensor comprises a mechanical switch that is moveable between a first position and a second position, the hygiene apparatus further comprising a biasing member that biases the mechanical switch towards the second position; wherein, when the hygiene apparatus is mounted to the support structure, the support structure engages with the mechanical switch so as to hold the mechanical switch in the first position; and wherein, when the hygiene apparatus is removed from the support structure, the mechanical switch disengages from the support structure and moves to the second position under the bias of the biasing member.
67. A hygiene apparatus, which optionally incorporates one or more features of any one or more of the preceding and/or following aspects, wherein the at least one sensor comprises a force sensor; and wherein the warning signal is produced when the force sensor detects a force applied to the hygiene apparatus that exceeds a force threshold.
68. A hygiene apparatus, which optionally incorporates one or more features of any one or more of the preceding and/or following aspects, wherein the at least one sensor comprises a piezoelectric sensor; wherein the piezoelectric sensor is configured to detect mechanical tension applied to the hygiene apparatus; and wherein the warning signal is produced when the piezoelectric sensor detects mechanical tension applied to the hygiene apparatus that exceeds a mechanical tension threshold.
69. A hygiene apparatus, which optionally incorporates one or more features of any one or more of the preceding and/or following aspects, wherein the at least one sensor comprises an accelerometer; and wherein the warning signal is produced when the accelerometer detects that the hygiene apparatus has fallen or has moved in an unexpected way.
70. A hygiene apparatus, which optionally incorporates one or more features of any one or more of the preceding and/or following aspects, wherein the at least one sensor comprises an orientation sensor; and wherein the warning signal is produced when the orientation sensor detects that the hygiene apparatus is in an unexpected orientation.
71. A hygiene apparatus, which optionally incorporates one or more features of any one or more of the preceding and/or following aspects, wherein the at least one sensor comprises a vibration sensor; and wherein the warning signal is produced when the vibration sensor detects vibrations of the hygiene apparatus that exceed a vibration threshold.
72. A hygiene apparatus, which optionally incorporates one or more features of any one or more of the preceding and/or following aspects, wherein the at least one sensor comprises at least one of: a smoke detector, a fire detector, and a heat detector.

### BRIEF DESCRIPTION OF THE DRAWINGS

Further aspects and advantages of the invention will appear from the following description taken together with the accompanying drawings, in which:

FIG. 1 is a front perspective view of a hand cleaning fluid dispenser in accordance with a first embodiment of the present invention;

FIG. 2 is a rear perspective view of the hand cleaning fluid dispenser shown in FIG. 1;

FIG. 3 is a side view of the top, rear corner of the hand cleaning fluid dispenser shown in FIG. 1;

FIG. 4 is a side view of the top, rear corner of the hand cleaning fluid dispenser shown in FIG. 1, with a side covering of the dispenser removed;

FIG. 5 is a perspective view of a sensor and communication unit of the hand cleaning fluid dispenser shown in FIG. 1;

FIG. 6 is a side view of the top, rear corner of a hand cleaning fluid dispenser in accordance with a second embodiment of the present invention, with a side covering of the dispenser removed;

FIG. 7 is a side view of the top, rear corner of a hand cleaning fluid dispenser in accordance with a third embodiment of the present invention, with a side covering of the dispenser removed;

FIG. 8 is a rear perspective view of a hand cleaning fluid dispenser in accordance with a fourth embodiment of the present invention;

FIG. 9 is a side view of the top, rear corner of the hand cleaning fluid dispenser shown in FIG. 8, showing the dispenser attached to a support structure;

FIG. 10 is a side view of the top, rear corner of the hand cleaning fluid dispenser shown in FIG. 8, showing the dispenser removed from the support structure;

FIG. 11 is a side view of the top, rear corner of a hand cleaning fluid dispenser in accordance with a fifth embodiment of the present invention, with a side covering of the dispenser removed; and

FIG. 12 is a side view of the top, rear corner of the hand cleaning fluid dispenser shown in FIG. 11, with an external object shown inserted into the dispenser.

### DETAILED DESCRIPTION OF THE DRAWINGS

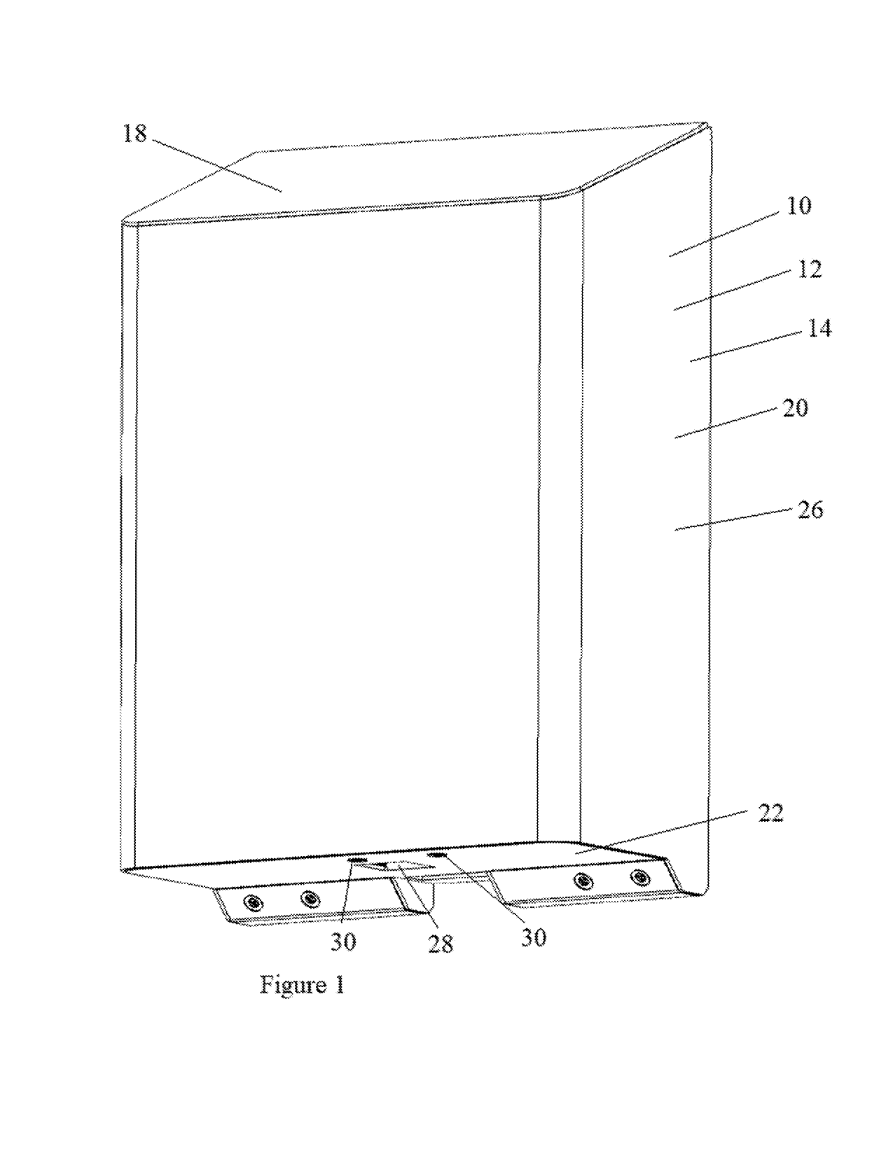

FIGS. 1-5 show a hygiene apparatus 10 in accordance with a first embodiment of the present invention. The hygiene apparatus 10 shown in the drawings is a hand cleaning fluid dispenser 12, though any other suitable device could be used instead, such as a bathroom tissue dispenser or a hand towel dispenser.

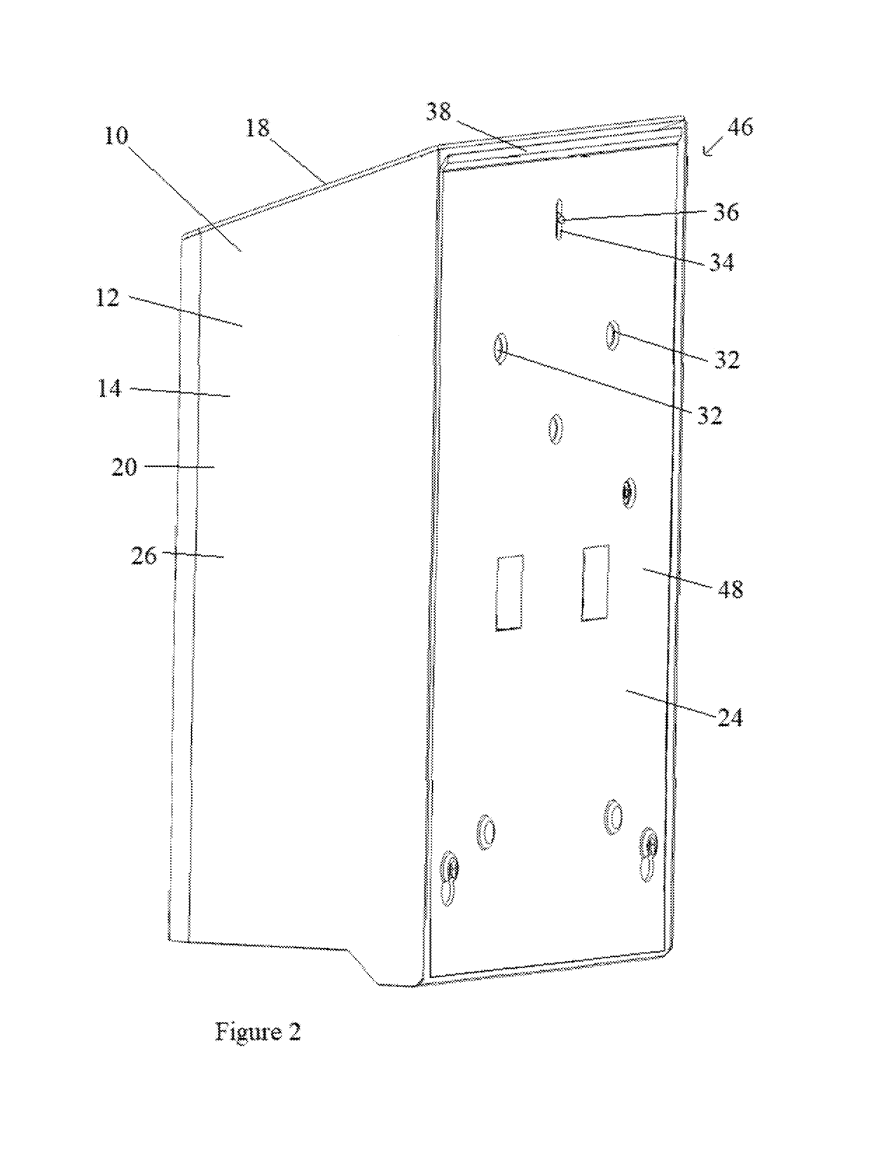

The fluid dispenser 12 has a housing 14, a sensor and communication unit 16, and a fluid storage and dispensing unit (not shown). The housing 14 carries and contains the fluid storage and dispensing unit. As can be seen in FIGS. 1 and 2, the housing 14 includes a top covering 18, a front and side covering 20, a bottom covering 22, and a back plate 24.

The top covering 18, the front and side covering 20, and the bottom covering 22 together form an outer casing 26 for the fluid dispenser 12 that prevents unauthorized individuals from physically accessing the fluid storage and dispensing unit stored therein. The bottom covering 22 has a small dispense opening 28 for dispensing hand cleaning fluid onto the hand of a user. Preferably, the dispense opening 28 is large enough to allow passage of the fluid out of the dispenser 12 and onto a user’s hand, but is too small to allow a user to manually access the fluid storage and dispensing unit through the dispense opening 28. The bottom covering 22 may also include one or more small windows 30 that are arranged so that an activation sensor (not shown) is able to detect the presence of a user’s hand below the dispense opening 28, to trigger the automatic dispensing of hand cleaning fluid from the dispenser 12.

The fluid storage and dispensing unit may have any suitable structure for storing and dispensing a hand cleaning fluid, including any of the structures and/or combinations of structures disclosed in any one or more of: United States Patent No. 8,245,877 to Ophardt, issued Aug. 21, 2012; United States Patent No. 8,113,388 to Ophardt et al., issued Feb. 14, 2012; United States Patent No. 8,091,739 to Ophardt et al., issued January 10, 2012; United States Patent No. 7,748,573 to Anhuf et al., issued Jul. 6, 2010; U.S. Patent No. 7,984,825 to Ophardt et al., issued Jul. 26, 2011; U.S. Patent No. 8,684,236 to Ophardt, issued Apr. 1, 2014; U.S. Patent No. 5,373,970 to Ophardt, issued Dec. 20, 1994; U.S. Patent No. 5,836,482 to Ophardt et al., issued Nov. 17, 1998; U.S. Patent No. 10,893,780 to Ophardt et al., issued 19 Jan. 2021; and U.S. Patent No. 9,682,390 to Ophardt et al., issued Jun. 20, 2017, which are incorporated herein by reference.

Preferably, the outer casing 26 does not have any sharp edges and does not have any attachment points or surfaces for attaching or supporting a ligature. As can be seen in FIG. 1, the top covering 20 preferably slopes forwardly and downwardly, so that any ligature placed on the top covering 20 will slide forwardly off of the dispenser 12.

As can be seen in FIG. 2, the back plate 24 is located at the rear of the dispenser 12, and has a number of attachment holes 32. The attachment holes 32 are for receiving fasteners (not shown) for securely attaching the dispenser 12 to a vertical support structure 44, such as a wall. The rear portion of the dispenser 12 that is adjacent to the vertical support structure 44 is referred to herein as the interface portion 46 of the dispenser 12.

As can be seen in FIG. 2, the back plate 24 also has an opening 34 for receiving a catch member 36 of the sensor and communication unit 16. Although the opening 34 is shown in FIG. 2 as being in the form of a vertical slot, any other suitable shape of the opening 34 could be used.

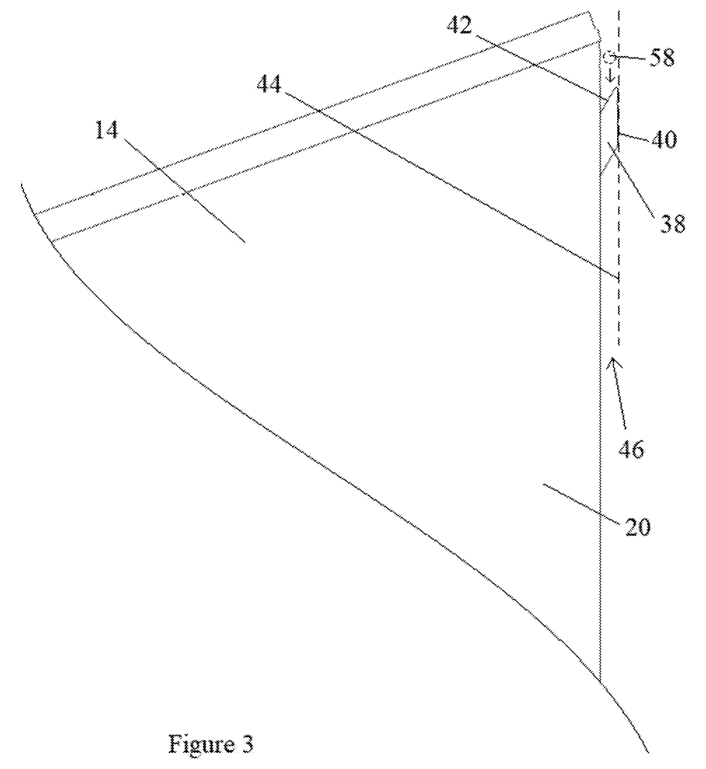

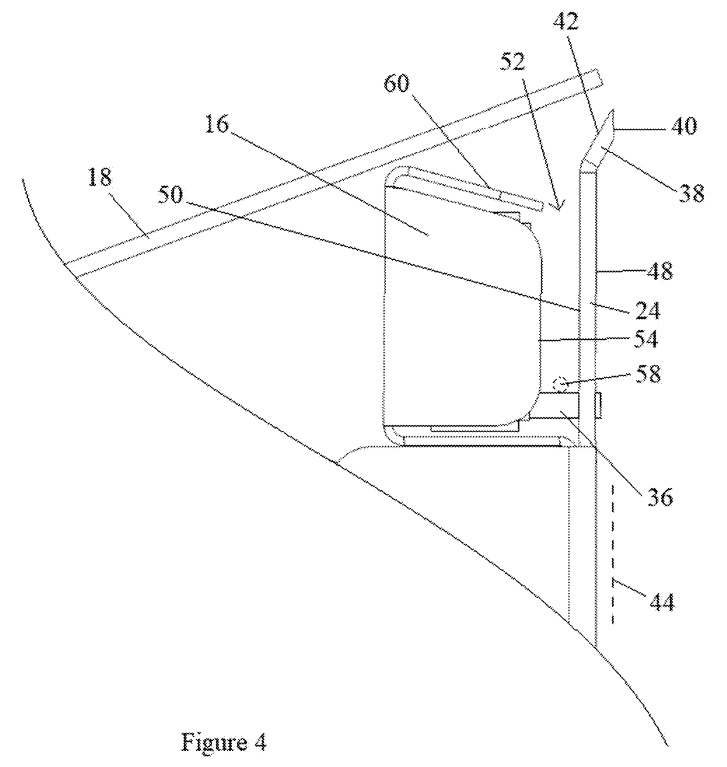

As is best shown in FIG. 4, the top portion of the back plate 24 forms a guide member 38. The guide member 38 extends upwardly and rearwardly, and has a support engagement surface 40 and a guide surface 42. The support engagement surface 40 is a vertical surface positioned at the rear of the guide member 38, for engaging with a vertical support structure 44 such as a wall. The vertical support structure 44 is shown in FIG. 3 as a dotted line. The guide surface 42 faces forwardly and upwardly, and extends forwardly and downwardly from the support engagement surface 40.

As can be seen in FIG. 4, the back plate 24 has an external surface 48 that faces towards the support structure 44, and an internal surface 50 that faces away from the support structure 44. The sensor and communication unit 16 is positioned below the top covering 18 and is spaced forwardly from the internal surface 50 of the back plate 24. The space between the sensor and communication unit 16 and the internal surface 50 of the back plate 24 is referred to herein as the detection zone 52.

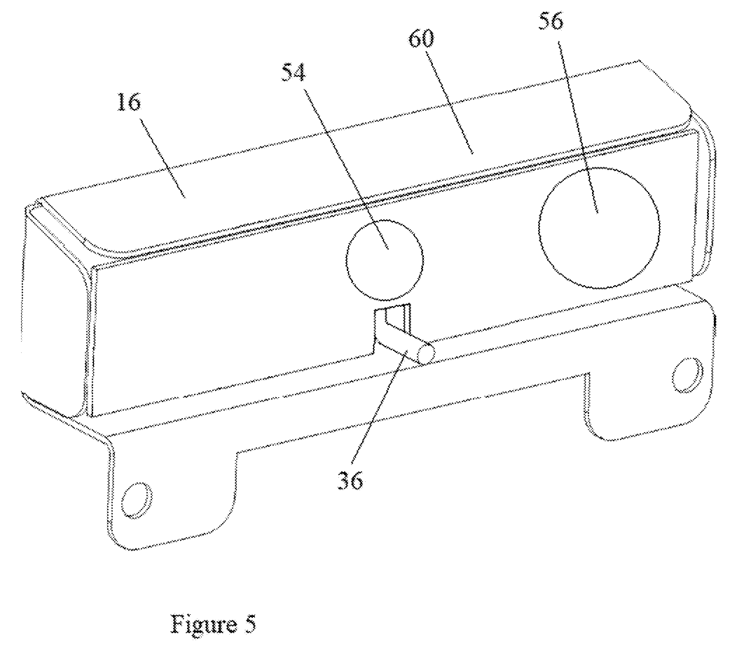

The sensor and communication unit 16 includes a sensor 54 and a communication device 56, which are shown schematically in FIG. 5. The sensor and communication unit 16 may also include additional electronic components such as a processor, a controller, a memory, and/or a battery.

In the embodiment shown in FIGS. 1-5, the sensor 54 has a catch member 36 that extends rearwardly from the sensor and communication unit 16, across the detection zone 52, and into the opening 34 in the back plate 24. The sensor 54 is configured to detect when an external object 58, such as a ligature, mechanically engages with the catch member 36. The sensor 54 may, for example, include a mechanical switch that is triggered when the catch member 36 is moved downwardly by the external object 58. Other suitable sensor arrangements or types of sensors 54 could also be used to detect engagement of the external object 58 with the catch member 36, including for example a force sensor and/or a piezoelectric sensor. The catch member 36 could also be configured to move when the external object 58 engages with the catch member 36, and this movement could be detected by a variety of different types of sensor 54, such as a capacitive sensor, an electromechanical sensor, a magnetic sensor, and/or an optical sensor.

The communication device 56 is configured to produce a warning signal when the sensor 54 detects engagement of an external object 58 with the catch member 36. The communication device 56 may, for example, include one or more of the following: a speaker for producing an audible signal; a light for producing a visible signal; a wired transmitter for transmitting an electronic signal via a wired connection; and/or a wireless transmitter for transmitting a wireless signal to one or more external devices, for example via radio, cellular, Wi-Fi and/or Bluetooth.

The operation of the fluid dispenser 12 will now be described with reference to FIGS. 1-5. The fluid dispenser 12 is configured to be mounted to a vertical support structure 44 in the orientation as shown in FIG. 1, with the top covering 18 positioned vertically above the bottom covering 22. The dispenser 12 is mounted to the support structure 44 by passing fasteners through the attachment holes 32 in the back plate 24. Preferably, the fasteners are sufficiently tightened so that the back plate 24 presses firmly against the support structure 44, with the support engagement surface 40 of the guide member 38 engaging with the support structure 44 as shown in FIG. 3.

In normal operation, the dispenser 12 is used to dispense hand cleaning fluid onto a user’s hand. To activate the dispenser 12, a user places his or her hands below the dispense opening 28, which triggers the automatic dispensing of an allotment of fluid, as is well known in the art.

The fluid dispenser 12 is also configured to detect dangerous interactions with the dispenser 12. In particular, the dispenser 12 shown in FIGS. 1-5 is configured to detect if an external object 58, such as a ligature, is inserted between the support structure 44 and the dispenser 12, as shown in FIG. 3. The guide member 38 is positioned so that the external object 58 inserted between the dispenser 12 and the support structure 44 will engage with the guide surface 42 of the guide member 38. The downwards and forwards slope of the guide surface 42 guides the external object 58 forwardly into the detection zone 52 between the sensor and communication unit 16 and the back plate 24, as shown in FIG. 4. Preferably, the sensor and communication unit 16 has an upper surface 60 that slopes rearwardly and downwardly, so as to guide the external object 58 rearwardly towards the detection zone 52 in the event that the external object 58 comes into contact with the upper surface 60.

As can be seen in FIG. 4, the object 58 moving downwardly through the detection zone 52 eventually engages with the catch member 36, which is detected by the sensor 54. The sensor 54 may employ any suitable mechanism for detecting the engagement between the object 58 and the catch member 36, including a mechanical switch, a force sensor, and/or a piezoelectric sensor.

On detection of the external object 58 engaging with the catch member 36, the communication device 56 is configured to emit a warning signal. The warning signal may, for example, include one or more of: an audible alarm, a flashing light, and a wireless signal that is transmitted to an external device, such as a wall mounted alarm system or a cell phone carried by nearby security personnel. The warning signal preferably allows nearby personnel to quickly investigate the source of the alarm, and intervene if the hygiene apparatus 10 is being used for self-harm or is otherwise being used in a dangerous manner.

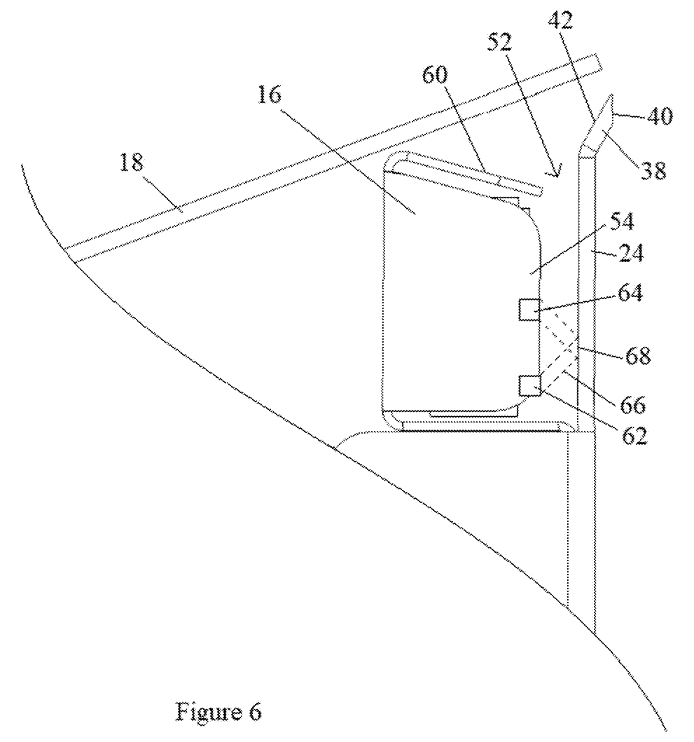

In other embodiments of the invention, the sensor 54 may use alternative methods of detecting the object 58, without requiring the catch member 36. For example, in the embodiment shown in FIG. 6, the catch member 36 has been replaced by an infrared emitter 62 and an infrared receiver 64. The infrared emitter 62 emits a beam 66 of infrared light, which travels from the sensor and communication unit 16 across the detection zone 62 towards a reflective surface 68 on the back plate 24. The beam 66 is then reflected back towards the sensor and communication unit 16, and is detected by the infrared receiver 64.

In the embodiment shown in FIG. 6, an external object 58 that is moving downwardly through the detection zone 52 will momentarily interrupt or break the beam 66 of infrared light, which is detected by the infrared receiver 64. On detection of the external object 58, the communication device 56 is configured to emit a warning signal, as in the previously described embodiment.

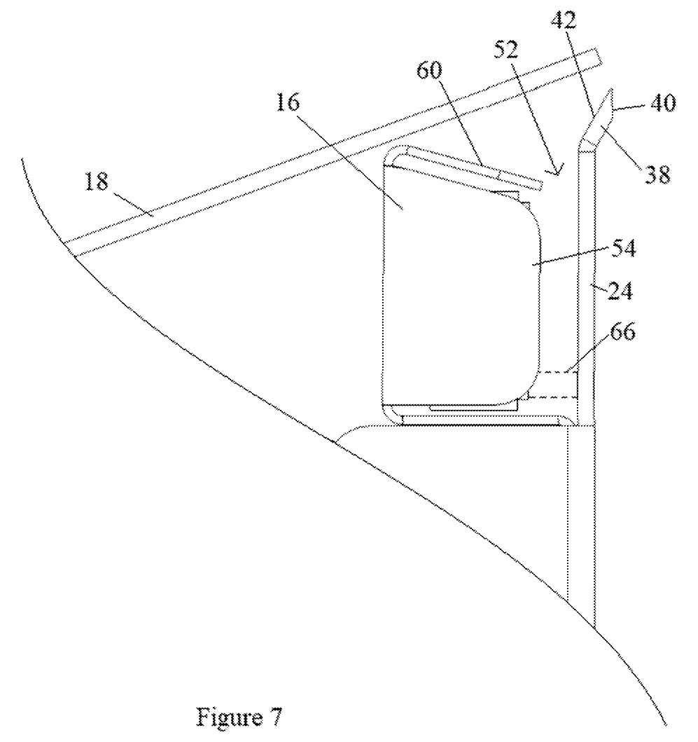

A further alternative configuration of the sensor 54 is shown in FIG. 7. The sensor 54 in FIG. 7 is a time of flight sensor, which emits a beam 66 of electromagnetic radiation and measures the amount of time required for the radiation to be reflected back to the sensor 54. When an external object 58 passes through the beam 66, the amount of time that it takes for the radiation to be reflected back to the sensor 54 will momentarily decrease, allowing the object 58 to be detected. As in the previous embodiments, the communication device 56 emits the warning signal when the external object 58 is detected.

Other than the specific differences described above, the embodiments of the invention shown in FIGS. 6 and 7 are identical to the embodiment shown in FIGS. 1-5, and like numerals are used to denote like components.

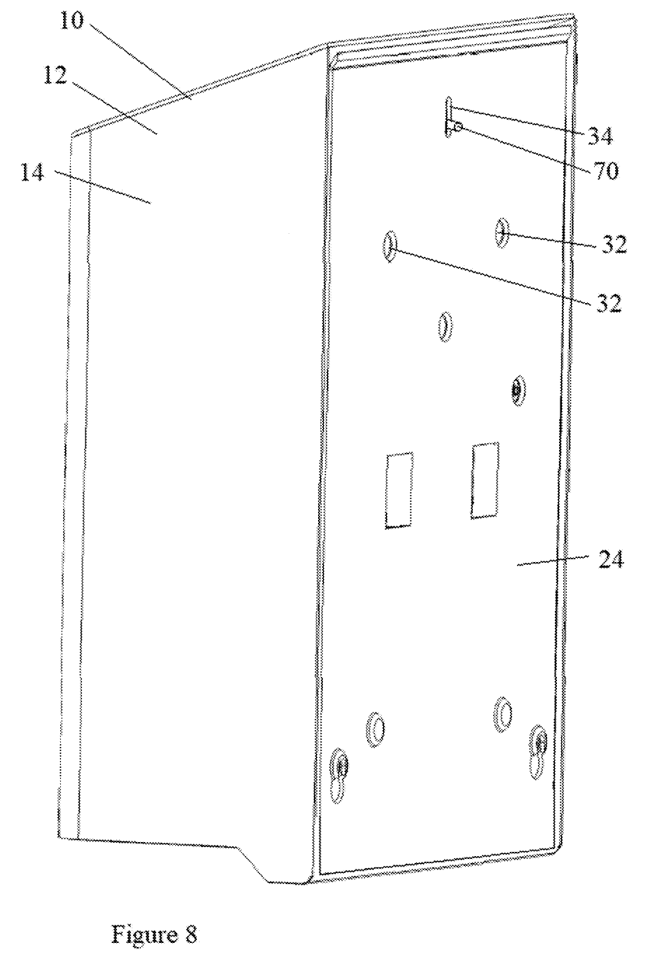

The dispenser 12 may also be configured to detect additional types of dangerous interactions. For example, in the embodiment shown in FIGS. 8-10, the dispenser 12 is configured to detect if the dispenser 12 has been removed from the support structure 44. Like numerals are used to denote like components.

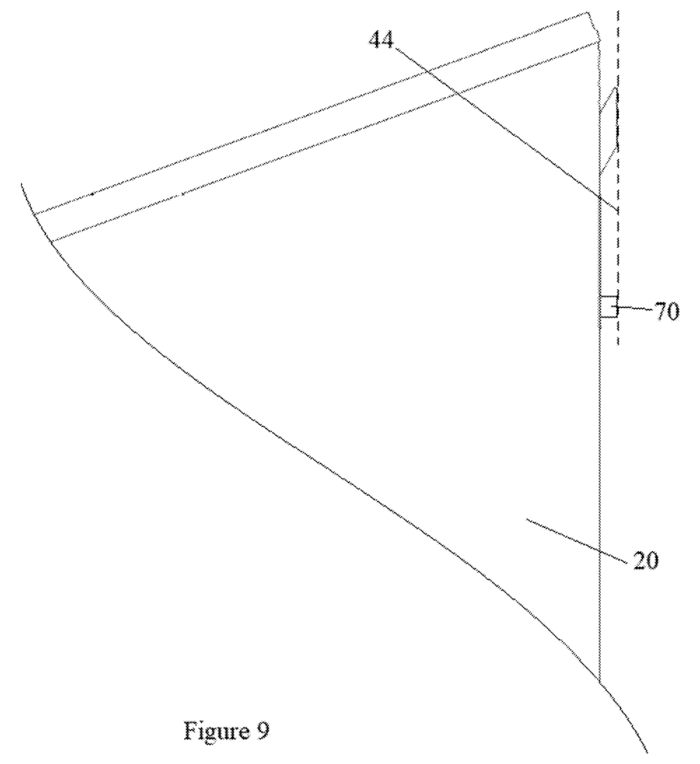

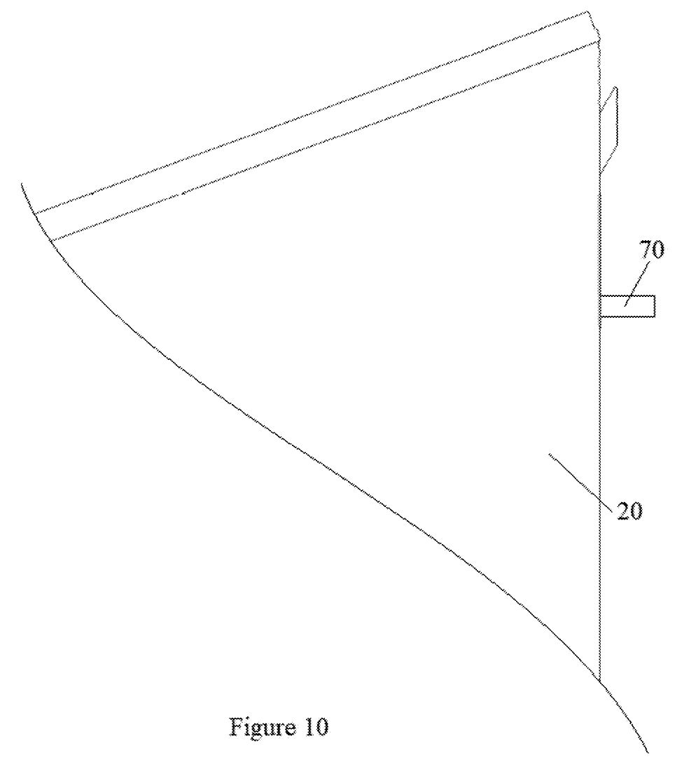

As can be seen in FIG. 8, the sensor 54 has a mechanical switch 70 that extends rearwardly from the back plate 24 (the mechanical switch 70 is provided in place of the catch member 36 shown in FIGS. 1-5). The mechanical switch 70 is configured to be movable between a retracted first position, shown in FIG. 9, and an extended second position, shown in FIG. 10. A biasing member (not shown), such as a spring, biases the mechanical switch 70 towards the second position.

As can be seen in FIG. 9, when the dispenser 12 is mounted to a support structure 44, the mechanical switch 70 engages with the support structure 44, which holds the mechanical switch 70 at the first position. When the dispenser 12 is removed from the support structure 44, as shown in FIG. 10, the mechanical switch 70 moves to the second position under the bias of the biasing member. The sensor 54 is thus able to detect whether the dispenser 12 has been removed from the support structure 44 based on the position of the mechanical switch 70.

On detecting that the dispenser 12 has been removed from the support structure 44, the communication device 56 is configured to emit a warning signal, as in the previous embodiments. This preferably allows nearby personnel to quickly investigate the source of the alarm, and intervene if the dispenser 12 is being used in a dangerous manner.

Other types of sensors 54 could also be used to detect if the dispenser 12 has been removed from the support structure 44, such as a time of flight sensor, an optical sensor, or a magnetic sensor.

Optionally, the hygiene apparatus 10 may be configured to incorporate more than one type of sensor 54. For example, the hygiene apparatus 10 may include one sensor 54 for detecting a ligature, and another sensor 54 for detecting if the dispenser 12 has been removed from the support structure 44.

The hygiene apparatus 10 may also incorporate one or more of the following sensors 54, in addition to or in place of the sensors 54 described above:
A) A force sensor, wherein the warning signal is produced when the force sensor detects a force applied to the hygiene apparatus 10 that exceeds a force threshold.
B) A piezoelectric sensor that detects mechanical tension applied to the hygiene apparatus 10, wherein the warning signal is produced when the piezoelectric sensor detects mechanical tension that exceeds a mechanical tension threshold.
C) An accelerometer, wherein the warning signal is produced when the accelerometer detects that the hygiene apparatus 10 has fallen or has moved in an unexpected way.
D) An orientation sensor, such as a gyroscope, wherein the warning signal is produced when the orientation sensor detects that the hygiene apparatus 10 is in an unexpected orientation.
E) A vibration sensor, wherein the warning signal is produced when the vibration sensor detects vibrations that exceed a vibration threshold.
F) A smoke detector.
G) A fire detector.
H) A heat detector.
I) A magnetic sensor.
H) An optical sensor.
J) An electromechanical sensor.
K) A leak detector or a water detector.
L) A capacitive sensor.

The thresholds are preferably selected so that the warning signal is activated only when the force, tension, acceleration, orientation, vibrations, smoke, and/or heat, etc., that are detected fall outside acceptable ranges that are expected during normal operation of the dispenser 12.

It will be understood that, although various features of the invention have been described with respect to one or another of the embodiments of the invention, the various features and embodiments of the invention may be combined or used in conjunction with other features and embodiments of the invention as described and illustrated herein.

The invention is not limited to the particular structures of the preferred embodiments that have been shown in the drawings. Rather, any functionally equivalent structures could be used.

In FIG. 6, the infrared emitter 62 and the infrared receiver 64 are both shown as being located on the sensor and communication unit 16. Alternatively, one of the emitter 62 or the receiver 64 could be located on the back plate 24. The emitter 62 and receiver 64 could also be configured to produce radiation other that infrared radiation, such as visible light.

The sensor 54 and the communication device 56 could be provided separately and need not be bundled together in a sensor and communication unit 16 as shown in the drawings.

The term “fluid” as used herein is intended to refer broadly to any flowable substance, including liquids, gels, foams, and emulsions. The hand cleaning fluid that is dispensed by the hand cleaning fluid dispenser may include, for example, soap, sanitizer, and/or disinfectant.

In some embodiments of the invention, the dispenser 12 may be configured to dispense liquid media such as soap or disinfectant. In other embodiments, the dispenser 12 may dispense solid media such as paper sheets or rolls, cotton, and fabrics made of plastic fibers. The invention could also be applied to other types of hygiene apparatuses, such as wall mounted waste bins, feminine hygiene product dispensers, wall mounted toilet brush holders, and toilet paper dispensers.

In some preferred embodiments of the invention, the battery level of the dispenser 12 is monitored, and a low battery level warning is provided when the remaining battery power falls below a threshold level. The low battery level warning may for example include an acoustic or visual display, such as on an LED display or a short audible beep.

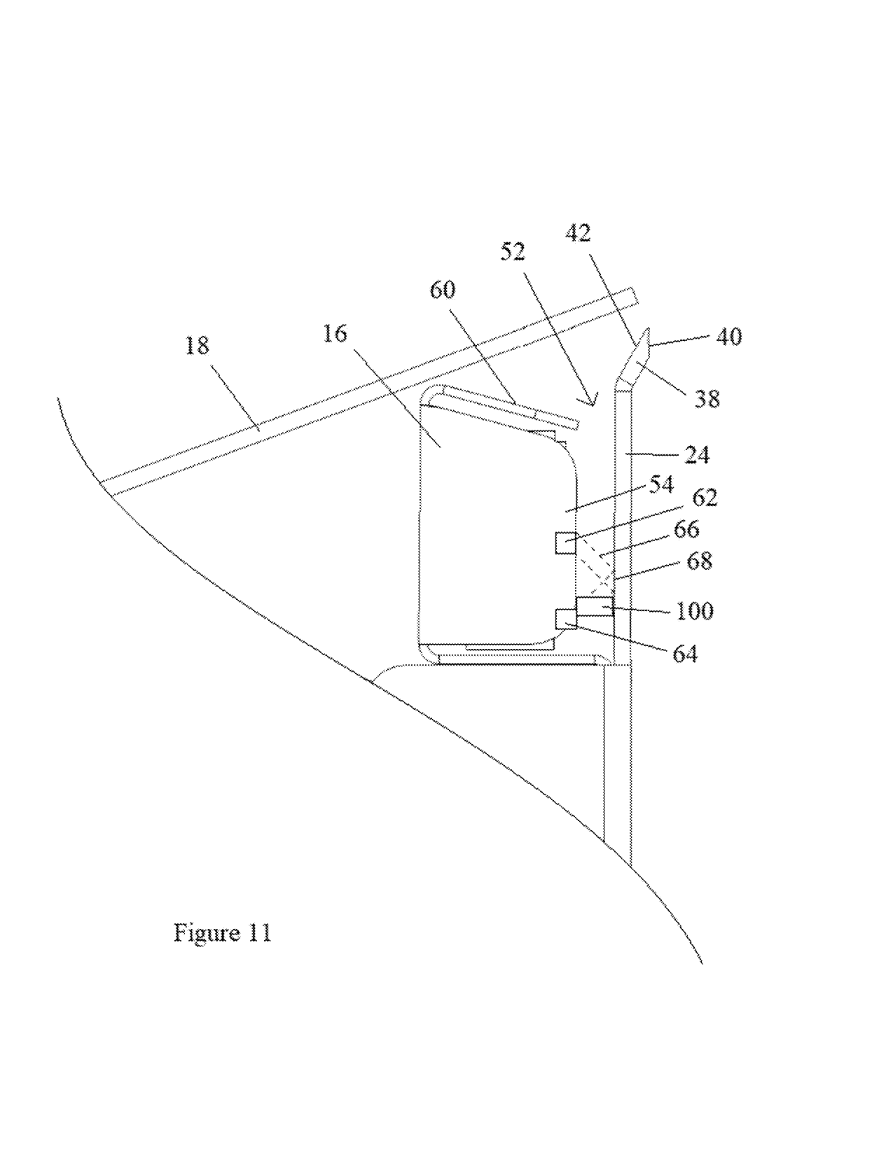

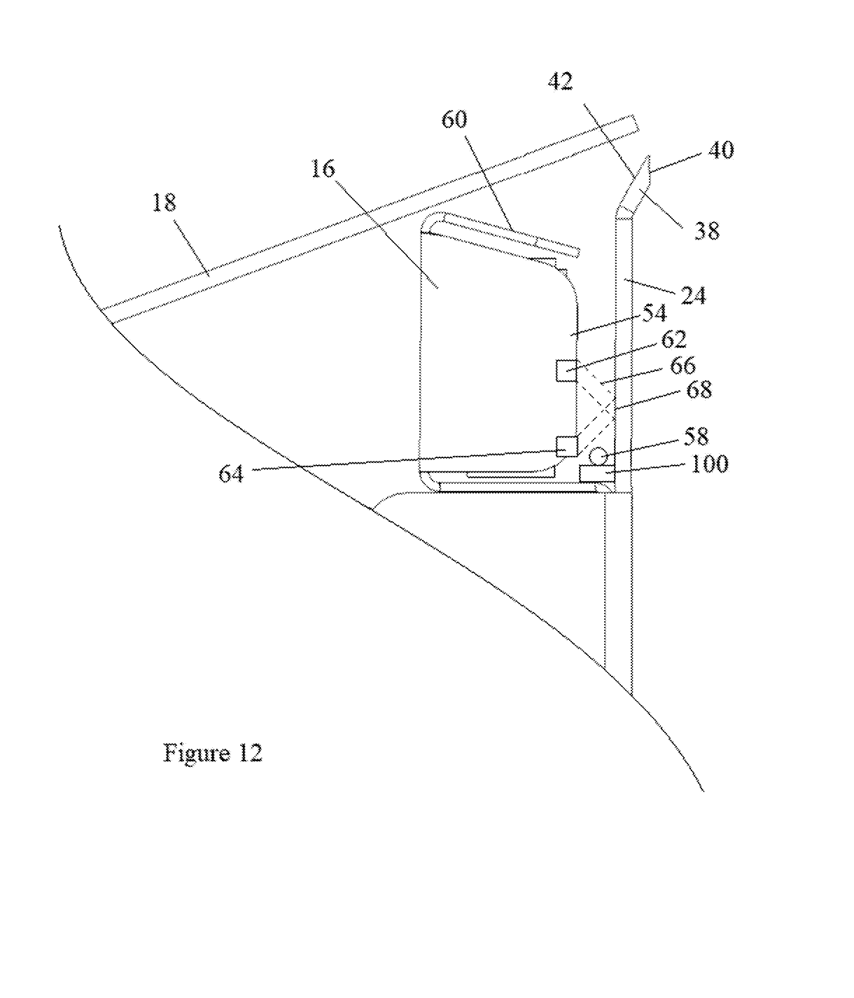

A further embodiment of the invention is shown in FIGS. 11 and 12, in which like numerals are used to denote like components. The embodiment shown in FIGS. 11 and 12 is identical to the embodiment shown in FIG. 6, except that the radiation emitter 62 and the radiation detector 64 are in different positions, and a radiation blocker 100 is positioned therebetween. The radiation blocker 100 is shown in the form of a plate, though any suitable structure could be used.

The radiation blocker 100 is movable between the first position shown in FIG. 11, and the second position shown in FIG. 12. When in the first position, the radiation blocker 100 obstructs the beam 66 of radiation emitted from the radiation emitter 62, preventing the beam 66 from reaching the radiation detector 64. When in the second position, the radiation blocker 100 does not obstruct the beam 66 of radiation, and the beam 66 can therefore be detected by the radiation detector 64. The radiation blocker 100 is biased towards the first position.

When an external object 58, such as a ligature, is inserted between the support structure 44 and the dispenser 12, the guide member 38 guides the external object 58 into engagement with the radiation blocker 100, as can be seen in FIG. 12. The engagement of the external object 58 with the radiation blocker 100 moves the radiation blocker from the first position to the second position. This allows the radiation detector 64 to detect the beam 66 of radiation, which can be used to trigger the activation of an alarm similar to the previously described embodiments.

In a further alternative configuration, the radiation blocker 100 could be configured to allow the beam 66 of radiation to reach the radiation detector 64 when in the first position, and block the beam 66 of radiation when in the second position. When in this configuration, the blocking of the beam 66 of radiation would be used as the signal to activate the alarm.

Although this disclosure has described and illustrated certain preferred embodiments of the invention, it is to be understood that the invention is not restricted to these particular embodiments. Rather, the invention includes all embodiments which are functional, optical, electrical, or mechanical equivalents of the specific embodiments and features that have been described and illustrated herein.

We claim:

1. A hygiene apparatus comprising:
at least one sensor that is configured to detect at least one type of dangerous interaction with the hygiene apparatus; and
a communication device that is configured to produce a warning signal on detection of the dangerous interaction.

2. The hygiene apparatus according to claim 1, wherein the hygiene apparatus comprises at least one of:
a hand cleaning fluid dispenser;
a bathroom tissue dispenser; and
a hand towel dispenser.

3. The hygiene apparatus according to claim 1, wherein the hygiene apparatus is configured to be mounted to a support structure;
wherein the hygiene apparatus comprises an interface portion that is adjacent to the support structure; and
wherein the at least one sensor is configured to detect an external object placed within the interface portion.

4. The hygiene apparatus according to claim 3, wherein the at least one sensor comprises a catch member that is configured to engage with the external object when the external object is placed within a detection zone of the interface portion; and
wherein the at least one sensor is configured to detect when the external object engages with the catch member.

5. The hygiene apparatus according to claim 3, wherein the at least one sensor comprises a radiation emitter and a radiation detector;
wherein the radiation emitter generates a beam of radiation that extends across a detection zone of the interface portion; and
wherein the radiation detector detects when the radiation beam is obstructed by passage of the external object through the detection zone.

6. The hygiene apparatus according to claim 4, further comprising a guide member that, when the external object is placed within the interface portion, is configured to guide the external object into the detection zone.

7. The hygiene apparatus according to claim 6, wherein the guide member comprises:
a support engagement surface that is configured to engage with the support structure; and
a guide surface that is configured to engage with the external object to guide the external object to the detection zone.

8. The hygiene apparatus according to claim 7, wherein, when the hygiene apparatus is mounted vertically, the guide surface slopes downwardly and outwardly away from the support structure.

9. The hygiene apparatus according to claim 7, further comprising a back plate that is configured to be fastened to the support structure;
wherein the back plate has an external surface that faces towards the support structure and an internal surface that faces away from the support structure; and
wherein the detection zone is located adjacent to the internal surface of the back plate.

10. The hygiene apparatus according to claim 9, wherein the catch member extends across the detection zone and into an opening in the back plate.

11. The hygiene apparatus according to claim 5, further comprising a guide member that, when the external object is placed within the interface portion, is configured to guide the external object into the detection zone;
wherein the guide member comprises:
a support engagement surface that is configured to engage with the support structure; and
a guide surface that is configured to engage with the external object to guide the external object to the detection zone;
wherein the hygiene apparatus further comprises a back plate that is configured to be fastened to the support structure;
wherein the back plate has an external surface that faces towards the support structure and an internal surface that faces away from the support structure;
wherein the detection zone is located adjacent to the internal surface of the back plate; and
wherein at least one of the radiation emitter and the radiation detector is located on the back plate.

12. The hygiene apparatus according to claim 5, further comprising a guide member that, when the external object is placed within the interface portion, is configured to guide the external object into the detection zone;
wherein the guide member comprises:
a support engagement surface that is configured to engage with the support structure; and
a guide surface that is configured to engage with the external object to guide the external object to the detection zone;
wherein the hygiene apparatus further comprises a back plate that is configured to be fastened to the support structure;
wherein the back plate has an external surface that faces towards the support structure and an internal surface that faces away from the support structure;
wherein the detection zone is located adjacent to the internal surface of the back plate;
wherein both the radiation emitter and the radiation detector are spaced from the back plate; and
wherein the back plate comprises a reflective surface for reflecting the beam of radiation towards the radiation detector.

13. The hygiene apparatus according to claim 1, wherein the hygiene apparatus is configured to be mounted to a support structure; and
wherein the at least one sensor is configured to detect if the hygiene apparatus has been removed from the support structure.

14. The hygiene apparatus according to claim 13, wherein the at least one sensor comprises a mechanical switch that is moveable between a first position and a second position, the hygiene apparatus further comprising a biasing member that biases the mechanical switch towards the second position;
wherein, when the hygiene apparatus is mounted to the support structure, the support structure engages with the mechanical switch so as to hold the mechanical switch in the first position; and
wherein, when the hygiene apparatus is removed from the support structure, the mechanical switch disengages from the support structure and moves to the second position under the bias of the biasing member.

15. The hygiene apparatus according to claim 1, wherein the at least one sensor comprises a force sensor; and
wherein the warning signal is produced when the force sensor detects a force applied to the hygiene apparatus that exceeds a force threshold.

16. The hygiene apparatus according to claim 1, wherein the at least one sensor comprises a piezoelectric sensor;
wherein the piezoelectric sensor is configured to detect mechanical tension applied to the hygiene apparatus; and
wherein the warning signal is produced when the piezoelectric sensor detects mechanical tension applied to the hygiene apparatus that exceeds a mechanical tension threshold.

17. The hygiene apparatus according to claim 1, wherein the at least one sensor comprises an accelerometer; and
wherein the warning signal is produced when the accelerometer detects that the hygiene apparatus has fallen or has moved in an unexpected way.

18. The hygiene apparatus according to claim 1, wherein the at least one sensor comprises an orientation sensor; and
wherein the warning signal is produced when the orientation sensor detects that the hygiene apparatus is in an unexpected orientation.

19. The hygiene apparatus according to claim 1, wherein the at least one sensor comprises a vibration sensor; and
wherein the warning signal is produced when the vibration sensor detects vibrations of the hygiene apparatus that exceed a vibration threshold.

20. The hygiene apparatus according to claim 1, wherein the at least one sensor comprises at least one of: a smoke detector, a fire detector, and a heat detector.
